(19) United States
(12) Patent Application Publication
(10) Pub. No.: US 2025/0379953 A1
(43) Pub. Date: Dec. 11, 2025

(54) ELECTRONIC DEVICE FOR EXECUTING MEDIA CONTENT CORRESPONDING TO EXTERNAL OBJECT BY USING EXTERNAL ELECTRONIC DEVICE, AND METHOD THEREFOR

(71) Applicant: SAMSUNG ELECTRONICS CO.,LTD., Suwon-si (KR)

(72) Inventors: Minjung SOHN, Suwon-si (KR); Jooyeon KIM, Suwon-si (KR); Seoungyeon ROH, Suwon-si (KR); Jiwon PARK, Suwon-si (KR); Donghee KANG, Suwon-si (KR)

(73) Assignee: SAMSUNG ELECTRONICS CO.,LTD., Suwon-si (KR)

(21) Appl. No.: 19/311,599

(22) Filed: Aug. 27, 2025

Related U.S. Application Data
(63) Continuation of application No. PCT/KR2024/000719, filed on Jan. 15, 2024.

(30) Foreign Application Priority Data
Feb. 27, 2023 (KR) 10-2023-0026357

(51) Int. Cl. H04N 5/74

(52) U.S. Cl. CPC H04N 5/74

(57) ABSTRACT

A processor of an electronic device may identify a plurality of external objects in an image acquired using a camera, obtain information about an application for performing one or more operations associated with one or more media contents, the one or more media contents being associated with the plurality of external objects, control the projection assembly using the information about the application to display the one or more media contents on a plane, wherein the application is accessible to a user, and wherein the user is identified using the camera, and in response to an input indicating selection of at least one media content among the one or more media contents, transmit, to an external electronic device associated with the user, a signal requesting execution of the one or more operations associated with of the at least one media content.

### CROSS-REFERENCES TO RELATED APPLICATION(S)

This application is a continuation of International Application No. PCT/KR2024/000719 designating the United States, filed on Jan. 15, 2024, in the Korean Intellectual Property Receiving Office and claiming priority to Korean Patent Application No. 10-2023-0026357, filed on Feb. 27, 2023, in the Korean Intellectual Property Office, the disclosures of which are all hereby incorporated by reference herein in their entireties.

### TECHNICAL FIELD

The present disclosure relates to an electronic device for executing media content corresponding to an external object by using an external electronic device and a method therefor.

### BACKGROUND

An electronic device for visualizing information is being developed. The electronic device may include a television, a monitor, an electronic display board, a beam projector, a mobile phone, and/or a tablet personal computer (PC). The electronic device may form a displaying area representing the information on a surface of the electronic device or on an external surface of the electronic device.

### SUMMARY

In an electronic device according to an embodiment, the electronic device may comprise a camera, communication circuitry, a projection assembly, at least one processor comprising processing circuitry, and memory comprising one or more storage mediums storing instructions. The instructions, when executed by the at least one processor individually or collectively, may cause the electronic device to identify a plurality of external objects in an image obtained using the camera. The instructions, when executed by the at least one processor individually or collectively, may cause the electronic device to obtain information about an application for performing one or more operations associated with one or more media contents, the one or more media contents being associated with the plurality of external objects. The instructions, when executed by the at least one processor individually or collectively, may cause the electronic device to control the projection assembly using the information about the application to display the one or more media contents on a plane, wherein the application is accessible to a user, and wherein the user is identified using the camera. The instructions, when executed by the at least one processor individually or collectively, may cause the electronic device to, in response to an input indicating selection of at least one media content among the one or more media contents, transmit, to an external electronic device associated with the user, a signal requesting execution of the one or more operations associated with of the at least one media content.

In a method of an electronic device according to an embodiment, the method may comprise identifying a plurality of external objects in an image obtained using a camera. The method may comprise obtaining information about an application for performing one or more operations associated with one or more media contents, the one or more media contents being associated with the plurality of external objects. The method may comprise controlling the projection assembly using the information about the application to displaying the one or more media contents on a plane, wherein the application is accessible to a user, and wherein the user is identified using a camera. The method may comprise, in response to an input indicating selection of at least one media content among the one or more media contents, transmitting, to an external electronic device associated with the user, a signal requesting execution of the one or more operations associated with of the at least one media content.

In an electronic device according to an embodiment, the electronic device may comprise a camera, communication circuitry, a projection assembly, and at least one processor. The instructions, when executed by the at least one processor individually or collectively, may cause the electronic device to identify a plurality of external objects in an image obtained using the camera. The instructions, when executed by the at least one processor individually or collectively, may cause the electronic device to obtain information about an application for performing one or more operations associated with one or more media contents, the one or more media contents being associated with the plurality of external objects. The instructions, when executed by the at least one processor individually or collectively, may cause the electronic device to obtain a usage history for each of the one or more media contents based on the information about the application accessible to a user, the user being identified using the camera. The instructions, when executed by the at least one processor individually or collectively, may cause the electronic device to obtain an order to display the one or more media contents by controlling the projection assembly and based on the usage history. The instructions, when executed by the at least one processor individually or collectively, may cause the electronic device to identify a plane near the plurality of external objects to display the one or more media contents. The instructions, when executed by the at least one processor individually or collectively, may cause the electronic device to display the one or more media contents on the plane by controlling the projection assembly based on the order.

### BRIEF DESCRIPTION OF DRAWINGS

FIG. 1 illustrates an example of an operation in which an electronic device according to an embodiment initiates execution of media content by using an external electronic device.

FIG. 2 illustrates an exemplary block diagram of an electronic device according to an embodiment.

FIG. 3 illustrates an example of an operation in which an electronic device according to an embodiment displays media contents corresponding to an external object.

FIG. 4 illustrates an exemplary flowchart indicating an operation of an electronic device according to an embodiment.

FIGS. 5A and 5B illustrate an example of an operation in which an electronic device according to an embodiment displays media contents based on identifying one user.

FIGS. 6A and 6B illustrate an example of an operation in which an electronic device according to an embodiment displays media contents based on identifying a plurality of users.

FIG. 7 illustrates an exemplary flowchart indicating an operation of an electronic device according to an embodiment.

FIG. 8 illustrates an example of an operation in which an electronic device according to an embodiment requests initiation of execution of media content to an external electronic device of a user identified using a camera.

FIG. 9 illustrates an exemplary flowchart indicating an operation of an electronic device according to an embodiment.

FIG. 10 is an exemplary diagram of a network environment related to a metaverse service.

### DETAILED DESCRIPTION

Hereinafter, various embodiments of the present document will be described with reference to the accompanying drawings.

The various embodiments of the present document and terms used herein are not intended to limit the technology described in the present document to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the present document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, are only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present document may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

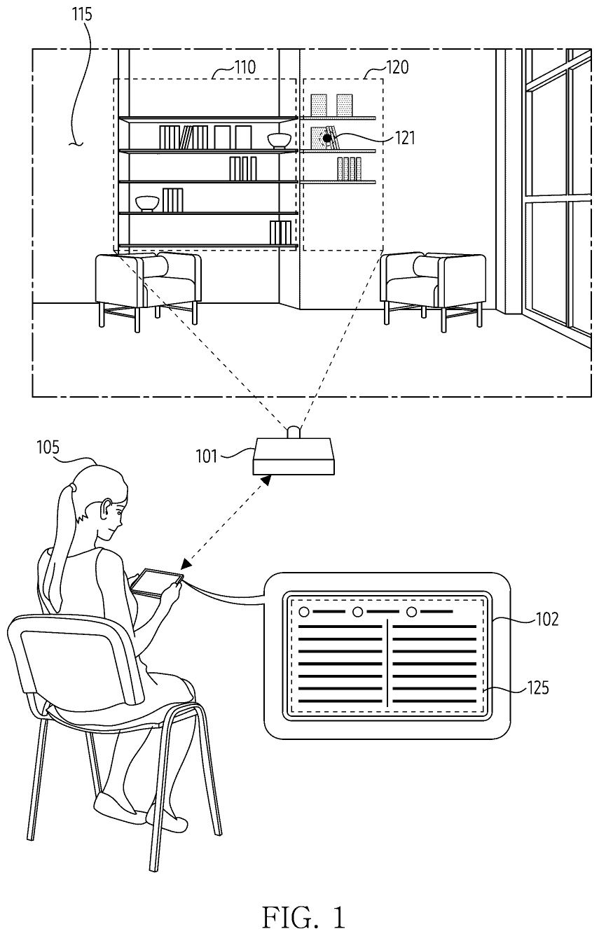

FIG. 1 illustrates an example of an operation in which an electronic device according to an embodiment initiates execution of media content by using an external electronic device.

Referring to FIG. 1, an electronic device 101 according to an embodiment may include a beam projector for emitting light to an external space. The electronic device 101 may output the light representing a screen (e.g., media contents 120) formed by pixels arranged two-dimensionally. The light outputted from the electronic device 101 may be reflected by an object such as a plane 115. A user 105 of the electronic device 101 may view the screen based on the light reflected by the object.

Referring to FIG. 1, in an external space reachable by light emitted by the electronic device 101, the electronic device 101 according to an embodiment may identify at least one plane 115 on which a screen (e.g., the media contents 120) represented by the light may be projectable. The electronic device 101 may identify a plurality of external objects 110 adjacent to the plane 115. For example, the plurality of external objects 110 may be located on an object (e.g., furniture, a bookshelf, and/or a desk) for including the plurality of external objects 110. The electronic device 101 may identify a type of the plurality of external objects 110 based on identifying the plurality of external objects 110 using a camera. For example, the electronic device 101 may distinguish each of the plurality of external objects 110 based on identifying a type such as a photograph, a book, a record, a lamp, etc. The electronic device 101 may identify, in an image obtained using the camera, the type of the plurality of external objects 110 based on identifying an exterior of the plurality of external objects 110 and/or text written on the plurality of external objects 110.

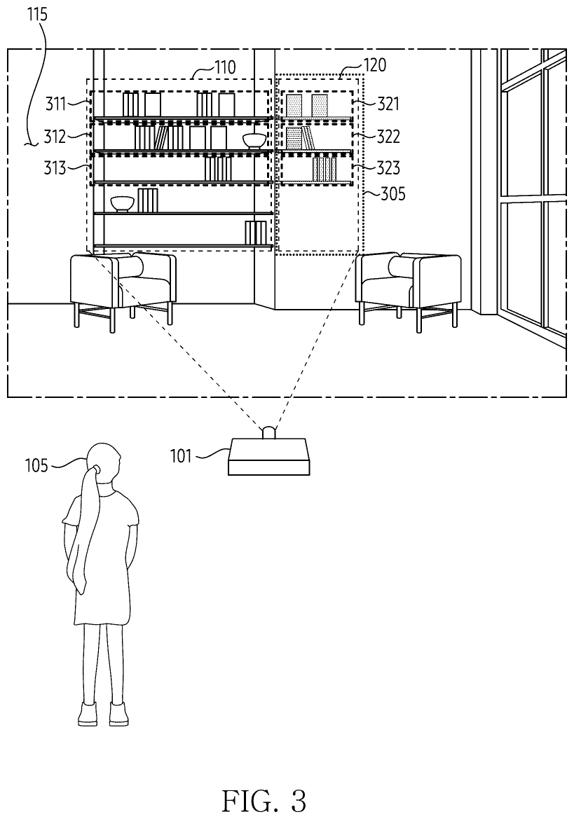

In embodiments, each of the media contents 120 corresponding to the plurality of external objects 110 may be different. For example, the electronic device 101 may identify a software application for executing, playing, displaying, implementing, rendering, or otherwise interacting with the media contents 120, based on the type of the plurality of external objects 110. As examples, the software application may include an application for providing a music service, an application for providing a reading service, and/or an application for providing at least one image. However, it is not limited thereto. As an example, the electronic device 101 may receive information on the media contents 120 corresponding to the plurality of external objects 110, from an external electronic device 102 of the user 105. An operation in which the electronic device 101 according to an embodiment obtains the media contents 120 based on identifying the plurality of external objects 110 is described below in FIG. 3.

The electronic device 101, according to an embodiment, may identify information (e.g., information on the plurality of external objects 110) on the external electronic device 102, which may be owned by the user 105, based on identifying the user 105 using the camera. The external electronic device 102 may be one or more devices. The external electronic device 102 may be an electronic device to which the user 105 of the electronic device 101 is logged in or is able to log in.

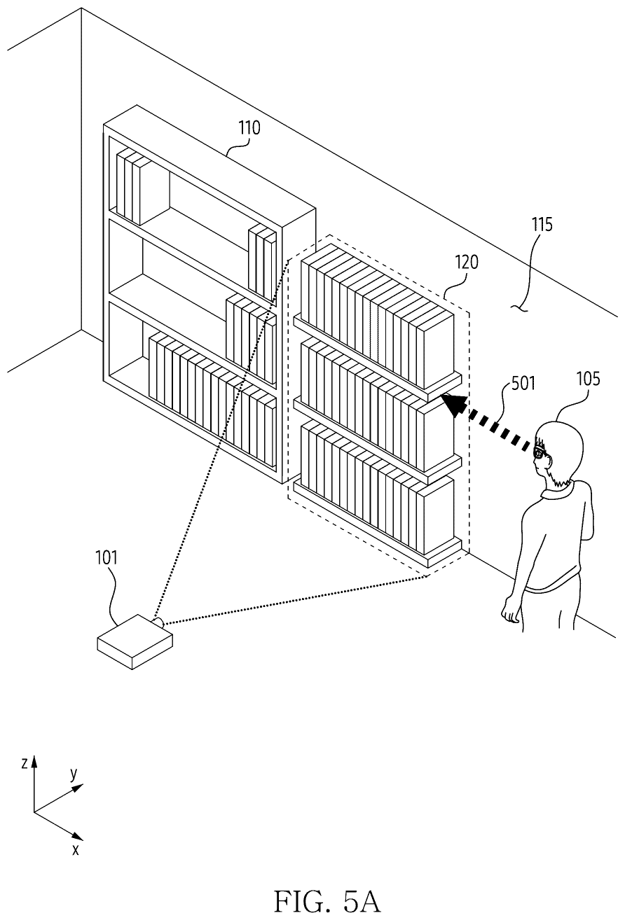

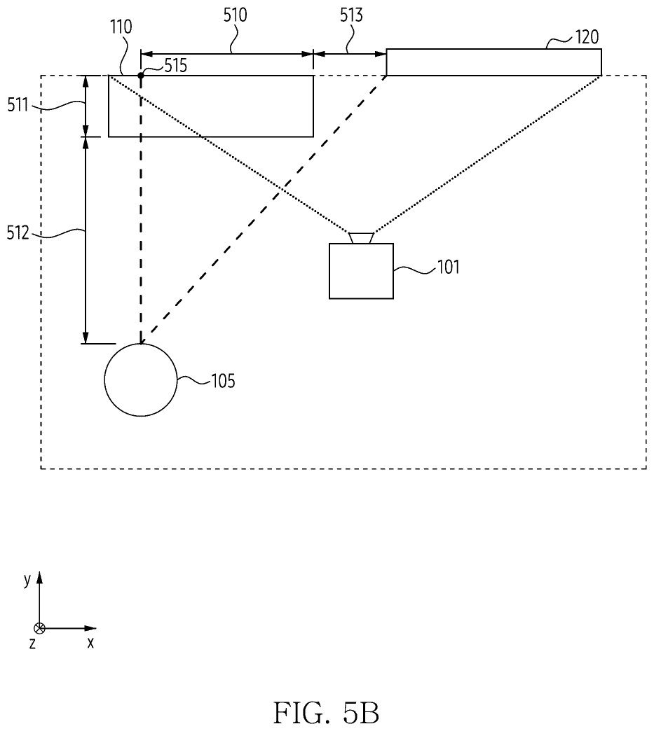

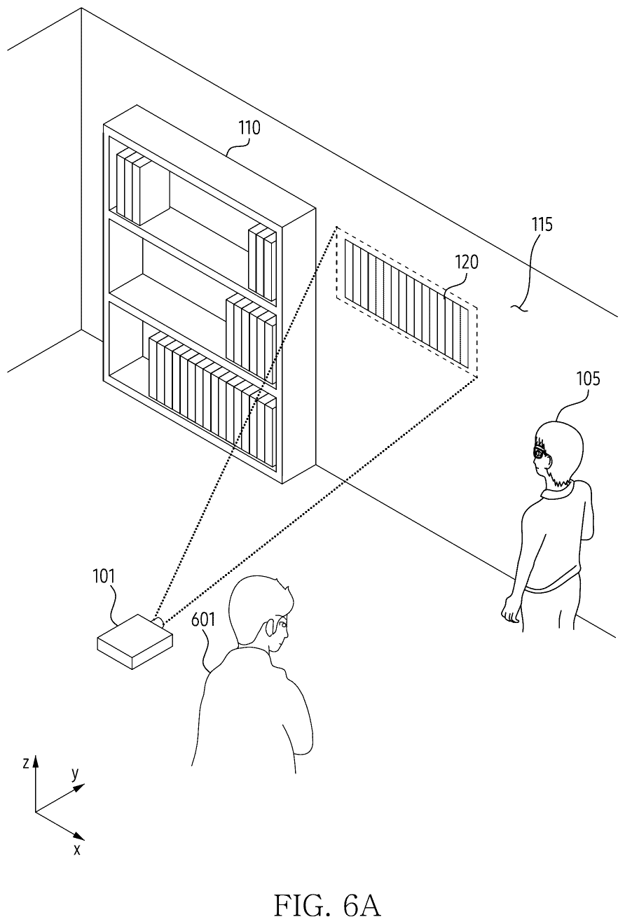

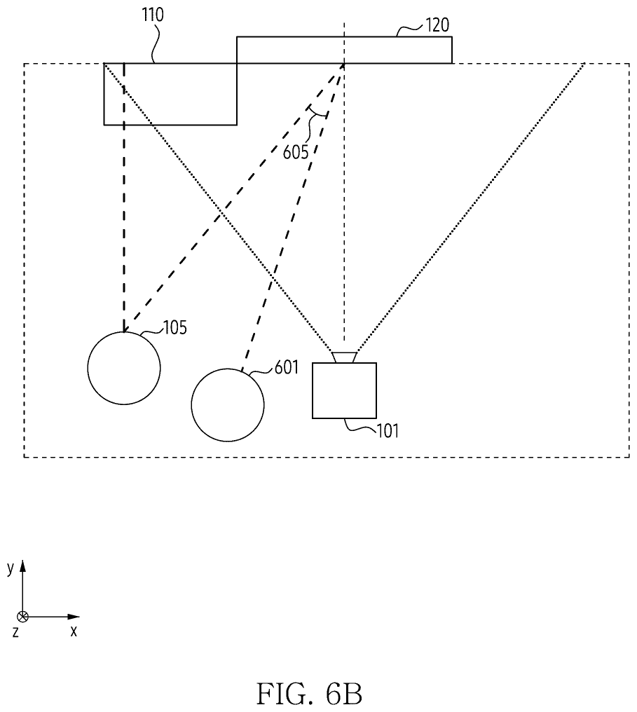

The electronic device 101 according to an embodiment may set or change a form of the media contents 120 based on identifying a location of the user 105. The form of the media contents 120 may be a multi-dimensional form, e.g., a three-dimensional-based form and/or a two-dimensional-based form. An operation in which the electronic device 101 sets the form of the media contents 120 based on identifying one or more users is described below in FIGS. 5A to 6B.

The electronic device 101 according to an embodiment may identify an input 121 indicating selection of at least one of the media contents 120 while displaying the media contents 120 on the plane 115 by controlling a projection assembly. The electronic device 101 may display the media contents 120 on the plane 115 adjacent to the plurality of external objects 110. For example, the electronic device 101 may display the media contents 120 overlappingly on the plurality of external objects 110.

For example, the electronic device 101 may identify the input 121 based on identifying a body part (e.g., a finger) of the user 105 in contact or interaction with the at least one displayed on the plane 115 by using the camera. The electronic device 101 may identify the input 121 using at least one controller. However, it is not limited thereto.

The electronic device 101 according to an embodiment may identify a software application for executing at least one media content corresponding to the input 121, in response to the input 121. The electronic device 101 may identify the external electronic device 102 on which the software application is installed. For example, the electronic device 101 may transmit a signal requesting initiation of the execution of the at least one media content to the external electronic device 102 through communication circuitry, based on identifying the external electronic device 102. The external electronic device 102 may include a terminal owned or controlled by the user 105. The terminal may include a personal computer (PC) such as a laptop and a desktop, a smartphone, a smartpad, a tablet PC, a smartwatch, a television (TV), an earphone, a speaker, and a smart device such as a head-mounted device (HMD). For example, the terminal may include a device for augmented reality such as augmented reality (AR) glasses. For example, the terminal may include a device for extended reality (XR) and/or mixed reality (MR). A type of the external electronic device 102 to which the electronic device 101 requests initiation of the execution of at least one media content may differ according to a type of the at least one media content. However, it is not limited thereto. As an example, the electronic device 101 may display the at least one media content by controlling the projection assembly, based on execution of the software application stored in memory, in response to the input 121.

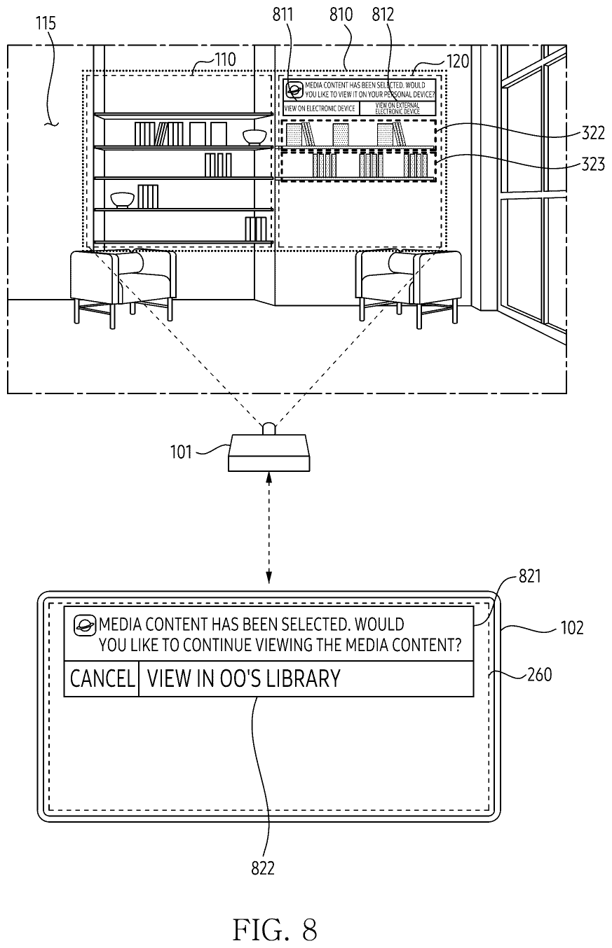

For example, the external electronic device 102 may display a screen 125 based on the at least one media content on a display of the external electronic device 102, based on receiving the signal from the electronic device 101 indicating initiation of the execution of the at least one media content. An operation in which the electronic device 101 transmits a signal requesting execution of media content to the external electronic device 102 is described below in FIG. 8.

As described above, the electronic device 101 according to an embodiment may obtain the media contents 120 corresponding to the plurality of external objects 110, based on identifying the plurality of external objects 110 using the camera. The media contents 120 may vary according to the user 105 identified by the electronic device 101. The electronic device 101 may display the media contents 120 on the plane 115 by controlling the projection assembly, based on a form of the plurality of external objects 110. In response to an input for selecting at least one media content among the media contents 120, the electronic device 101 may identify the external electronic device 102 for requesting execution of the at least one media content. The electronic device 101 may transmit a signal to the external electronic device 102 to request the execution. The external electronic device 102 may display the screen 125 based on the execution of the at least one media content on a display, in response to the signal requesting the execution of the at least one media content. The electronic device 101 may provide an Internet of Things (IOT) environment to the user 105 by displaying the media contents 120 corresponding to the plurality of external objects 110, by using one or more electronic devices of the user 105.

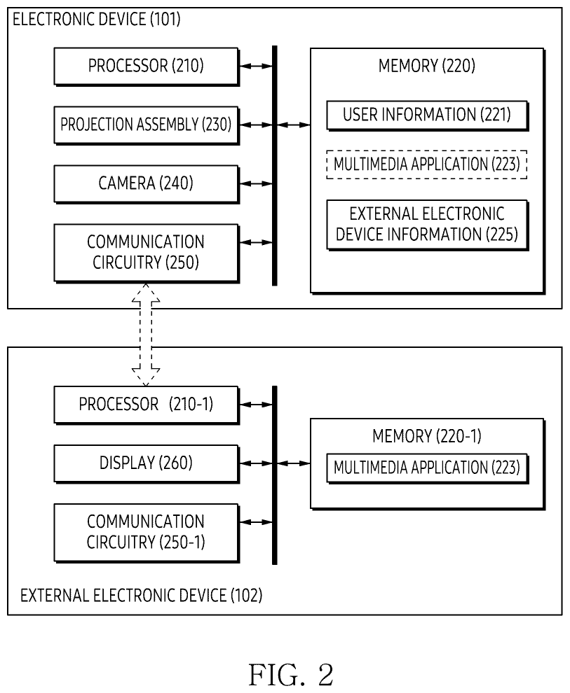

FIG. 2 illustrates an exemplary block diagram of an electronic device according to an embodiment. An electronic device 101 of FIG. 2 may be an example of the electronic device 101 of FIG. 1. An external electronic device 102 of FIG. 2 may be an example of the external electronic device 102 of FIG. 1. Referring to FIG. 2, the electronic device 101 and the external electronic device 102 may be connected to each other based on a wired network and/or a wireless network. The wired network may include a network such as the Internet, a local area network (LAN), a wide area network (WAN), Ethernet, or a combination thereof. The wireless network may include a network such as long term evolution (LTE), 5 g new radio (NR), wireless fidelity (WiFi), Zigbee, near field communication (NFC), Bluetooth, Bluetooth low-energy (BLE), or a combination thereof. Although the electronic device 101 and the external electronic device 102 are illustrated as being directly connected, the electronic device 101 and the external electronic device 102 may be indirectly connected through an intermediate node (e.g., a router and/or an access point (AP)).

Referring to FIG. 2, according to an embodiment, the electronic device 101 may include at least one of a processor 210, memory 220, a projection assembly 230, a camera 240, or communication circuitry 250. The processor 210, the memory 220, the projection assembly 230, the camera 240, and the communication circuitry 250 may be electronically and/or operably coupled with each other by an electronic component such as a communication bus. Hereinafter, hardware being operably coupled may mean that a direct connection or an indirect connection between the hardware is established, either wired or wirelessly, such that second hardware is controlled by first hardware among the hardware. Although illustrated based on different blocks, an embodiment is not limited thereto, and a portion (e.g., at least a portion of the processor 210, the memory 220, and the communication circuitry 250) of the hardware of FIG. 2 may be included in a single integrated circuit, such as a system on a chip (SoC). A type and/or the number of hardware components included in the electronic device 101 is not limited to those illustrated in FIG. 2. For example, the electronic device 101 may include only a portion of the hardware components illustrated in FIG. 2.

According to an embodiment, the processor 210 of the electronic device 101 may include a hardware component for processing data based on one or more instructions. The hardware component for processing data may include, for example, an arithmetic and logic unit (ALU), a floating point unit (FPU), a field programmable gate array (FPGA), a central processing unit (CPU), and/or an application processor (AP). The number of the processor 210 may be one or more. For example, the processor 210 may have a multi-core processor structure such as a dual core, a quad core, or a hexa core.

According to an embodiment, the memory 220 of the electronic device 101 may include a hardware component for storing data and/or instructions inputted to and/or outputted from the processor 210. The memory 220 may include, for example, volatile memory such as random-access memory (RAM) and/or non-volatile memory such as read-only memory (ROM). The volatile memory may include, for example, at least one of dynamic RAM (DRAM), static RAM (SRAM), Cache RAM, or pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), or an embedded multi media card (eMMC).

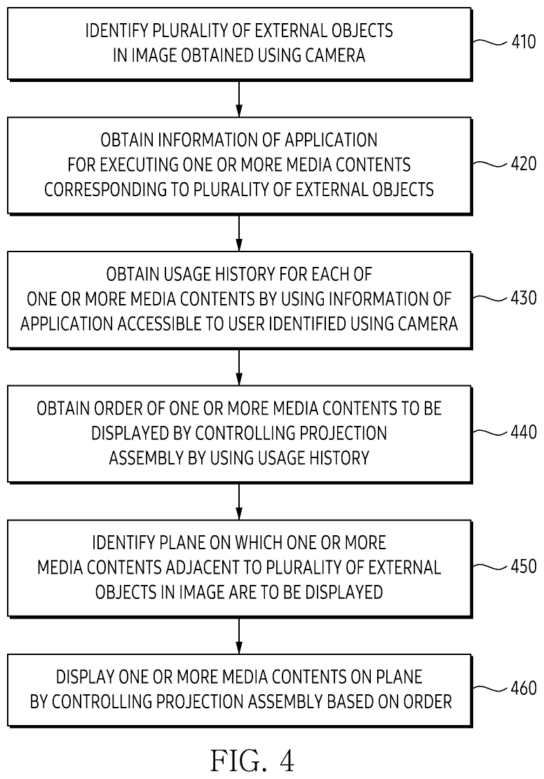

According to an embodiment, in the memory 220 of the electronic device 101, one or more instructions (or commands) indicating a computation and/or an operation to be performed by the processor 210 on data may be stored. A set of one or more instructions may be referred to as firmware, an operating system, a process, a routine, a sub-routine, and/or an application. For example, the electronic device 101 and/or the processor 210 may perform at least one of operations of FIG. 4, 7, or 9 when a set of a plurality of instructions distributed in a form of an operating system, firmware, a driver, and/or an application is executed. Hereinafter, that an application is installed in the electronic device 101 may mean that one or more instructions provided in a form of an application are stored in the memory 220 of the electronic device 101, and that the one or more applications are stored in a format (e.g., a file having an extension designated by an operating system of the electronic device 101) executable by the processor 210 of the electronic device 101.

The electronic device 101 according to an embodiment may identify a user in an image obtained using the camera 240. The electronic device 101 may identify the user by using user information 221. The user information 221 may include information on a user logged into the electronic device 101. The user information 221 may include information on a plurality of users. The electronic device 101 may obtain external electronic device information 225 corresponding to the user by using the user information 221. The electronic device 101 may obtain information on one or more external electronic devices owned by the user by using the external electronic device information 225. The electronic device 101 may identify a type of one or more external electronic devices owned by the user by using the external electronic device 102. The one or more external electronic devices may be a terminal to which the user is logged in. The electronic device 101 may identify each of the one or more external electronic devices by using the communication circuitry 250.

The electronic device 101 according to an embodiment may obtain media content corresponding to an external object identified through the camera 240, based on execution of a multimedia application 223. The multimedia application 223 may vary according to a type of the external object.

For example, in a case that the external object is related to a book, the multimedia application 223 may be an example of a software application that provides a service related to books. In a case that the external object is related to a photograph, the multimedia application 223 may be a software application for providing an image. In a case that the external object is related to a record, the multimedia application 223 may be a software application for providing music. However, it is not limited thereto.

For example, the electronic device 101 may synchronize information on the multimedia application 223 with the external electronic device 102, in a state in which a communication link has been established with the external electronic device 102 through the communication circuitry 250. As an example, in a case that the multimedia application 223 is not installed in the memory 220 of the electronic device 101, in a state in which the communication link has been established, the electronic device 101 may request information on the multimedia application 223 from the external electronic device 102.

The electronic device 101 according to an embodiment may request information on a user identified using the camera 240 from an external server providing the multimedia application 223, based on the execution of the multimedia application 223. For example, the information on the user may include information on media content provided by the multimedia application 223. The information on the user may include a usage history of the media content. The information on the user may include information on a date of purchase, the number of views, and/or a viewing date of the media content. The electronic device 101 may obtain an order of the media content by using the information on the user. The electronic device 101 may select media content to be displayed by controlling a projection assembly based on the order. An operation in which the electronic device 101 displays the selected media content is described below in FIG. 3.

According to an embodiment, the projection assembly 230 of the electronic device 101 may include a plurality of hardware components assembled to emit light representing pixels. The pixels may be arranged two-dimensionally. For example, the projection assembly 230 may include a combination of cathode-ray tubes (CRTs) for emitting light corresponding to each of three primary colors in a color space, and lenses for magnifying the light emitted from each of the CRTs. In the same or another example, the projection assembly 230 may include a combination of a light source (e.g., a lamp) for emitting light, optical filters for splitting the light into light paths corresponding to each of the three primary colors, liquid crystal display (LCD) panels disposed in each of the light paths, and a prism and/or a lens for synthesizing light outputted from the LCD panels. For example, the projection assembly 230 may include a combination of a light source for emitting light, an optical filter that selects any one of the three primary colors from the light, a digital mirror device (DMD) for adjusting reflection of the primary color filtered by the optical filter, and a lens for magnifying the light reflected by the DMD. In terms of requiring projection of light for displaying a screen, at least one of the exemplified combinations may be referred to as the projection assembly 230. In an embodiment, the electronic device 101 including the projection assembly 230 may be referred to as a beam projector.

According to an embodiment, the camera 240 of the electronic device 101 may include one or more optical sensors (e.g., a charged coupled device (CCD) sensor and a complementary metal oxide semiconductor (CMOS) sensor) that generate an electrical signal indicating color and/or brightness of light. A plurality of optical sensors in the camera 240 may be arranged in a form of a 2 dimensional array. The camera 240 may obtain electrical signals from each of the plurality of optical sensors substantially simultaneously, thereby generating an image corresponding to light that reached the optical sensors of the 2 dimensional array, and including a plurality of pixels arranged two-dimensionally. For example, photo data captured using the camera 240 may mean an image obtained from the camera 240. For example, video data captured using the camera 240 may mean a sequence of a plurality of images obtained from the camera 240 according to a designated frame rate.

The electronic device 101 according to an embodiment may identify a plurality of external objects (e.g., the plurality of external objects 110 of FIG. 1) in an image obtained using the camera 240. The electronic device 101 may obtain media contents (e.g., the media contents 120 of FIG. 1) based on identifying a type of the plurality of external objects. For example, the electronic device 101 may obtain the media contents based on the execution of the multimedia application 223. An operation in which the electronic device 101 obtains media contents based on the type of the plurality of external objects is described below in FIG. 3.

Using the camera 240 included in the electronic device 101 according to an embodiment, a user (e.g., the user 105 of FIG. 1) included in an obtained image and/or video may be identified. The electronic device 101 identifying the user may be performed based on a sensor for identifying a distance between the electronic device 101 and the user, such as a depth sensor and/or a time of flight (ToF) sensor. The depth sensor may include an ultra wide band (UWB) sensor (or UWB radar) that uses a wireless signal in UWB frequency band. The depth sensor may include a ToF sensor that measures a time-of-flight (ToF) of laser light and/or infrared light. The electronic device 101 may obtain a depth video including depth values arranged two-dimensionally by using the ToF sensor. The ToF sensor may include an infrared diode and a plurality of infrared optical sensors that detect intensity of infrared light and are arranged in a form of a 2 dimensional array. The electronic device 101 may obtain the depth video, which is based on a time when light emitted from the infrared diode is reflected from a subject and reaches at least one of the plurality of infrared optical sensors, using the ToF sensor. An operation in which the electronic device 101 identifies an application accessible to the user, based on identifying the user, is described below in FIG. 3.

According to an embodiment, the communication circuitry 250 of the electronic device 101 may include hardware for supporting transmission and/or reception of an electrical signal between the electronic device 101 and the external electronic device 102. Although only the external electronic device 102 is illustrated as another electronic device connected through the communication circuitry 250 of the electronic device 101, an embodiment is not limited thereto. The communication circuitry 250 may include, for example, at least one of a modem, an antenna, or an optic/electronic (O/E) converter. The communication circuitry 250 may support transmission and/or reception of an electrical signal based on various types of protocols, such as Ethernet, local area network (LAN), wide area network (WAN), wireless fidelity (WiFi), Bluetooth, Bluetooth low energy (BLE), ZigBee, long term evolution (LTE), and 5G new radio (NR).

Referring to FIG. 2, the external electronic device 102 connected to the electronic device 101 may include at least one of a processor 210-1, memory 220-1, communication circuitry 250-1, or a display 260. The processor 210-1, the memory 220-1, the communication circuitry 250-1, and the display 260 may be electronically and/or operably coupled with each other by a communication bus. The processor 210-1, the memory 220-1, and the communication circuitry 250-1 in the external electronic device 102 of FIG. 2 may correspond to the processor 210, the memory 220, and the communication circuitry 250 in the electronic device 101. To reduce redundancy in the description, descriptions of the processor 210-1, the memory 220-1, and the communication circuitry 250-1 that overlap with the descriptions of the processor 210, the memory 220, and the communication circuitry 250 may be omitted.

The display 260 of the external electronic device 102 according to an embodiment may output visualized information to a user. For example, the display 260 may output visualized information to the user by being controlled by the processor 210 and/or a graphic processing unit (GPU) (not illustrated). The display 260 may include a flat panel display (FPD) and/or electronic paper. The FPD may include a liquid crystal display (LCD), a plasma display panel (PDP), a digital mirror device (DMD), one or more light emitting diodes (LEDs), and/or a micro LED. The LED may include an organic LED (OLED).

The external electronic device 102 according to an embodiment may receive a signal requesting execution of media content from the electronic device 101 by using the communication circuitry 250-1. The external electronic device 102 may initiate execution of an application (e.g., the multimedia application 223) for executing the media content, based on receiving the signal. The external electronic device 102 may display a screen corresponding to the media content on the display 260, based on the execution of the application.

As described above, the electronic device 101 according to an embodiment may identify a plurality of external objects (e.g., the plurality of external objects 110 of FIG. 1) using the camera 240. The electronic device 101 may obtain media content corresponding to each of the plurality of external objects, based on identifying the plurality of external objects. The electronic device 101 may obtain the media content based on the execution of the multimedia application 223. The electronic device 101 may display the obtained media content on a plane by controlling a projection assembly. In response to an input indicating selection of the displayed media content, the electronic device 101 may transmit a signal indicating the display of the media content, using the communication circuitry 250, to the external electronic device 102 for displaying the media content. The electronic device 101 may enhance user convenience by using the external electronic device 102 to display the media content.

FIG. 3 illustrates an example of an operation in which an electronic device according to an embodiment displays media contents corresponding to an external object. An electronic device 101 of FIG. 3 may include the electronic device 101 of FIGS. 1 to 2.

Referring to FIG. 3, the electronic device 101 according to an embodiment may identify a plurality of external objects 110 using a camera (e.g., the camera 240 of FIG. 2). For example, the electronic device 101 may identify a shape in which the plurality of external objects 110 are arranged. The shape may vary according to whether each of the plurality of external objects 110 is arranged facing the front and/or facing the side. The shape may vary according to the number of the plurality of external objects 110. As an example, the electronic device 101 may identify whether each of the plurality of external objects 110 is arranged densely or spaciously. However, it is not limited thereto. As an example, the shape may include a shape of a real object (e.g., furniture or a shelf) that includes the plurality of external objects 110. As an example, the shape may include a stacked shape or an upright shape of the plurality of external objects 110.

The electronic device 101 according to an embodiment may identify a type of each of the plurality of external objects 110. For example, the electronic device 101 may identify an external object 311 to be a photograph. The electronic device 101 may identify a first software application (e.g., an application for providing an image) for executing or displaying media content (e.g., an image) corresponding to the external object 311, based on identifying the external object 311. For example, the electronic device 101 may identify an external object 312 to be a book. The electronic device 101 may identify a second software application for providing information related to a book or for reading or listening to the book, based on identifying the external object 312. For example, the electronic device 101 may identify an external object 313 to be related to a record. The electronic device 101 may identify a third software application for providing music, based on identifying the external object 313. The electronic device 101 may obtain media contents 120 based on executing the first software application, the second software application, and/or the third software application, respectively. However, it is not limited thereto. For example, based on identifying a plurality of users, the electronic device 101 may obtain media contents corresponding to each of the plurality of users. As an example, the electronic device 101 may display media content 321 corresponding to a first user, media content 322 corresponding to a second user, and/or media content 323 corresponding to a third user together on a plane 115.

For example, the electronic device 101 may display the media contents 120 based on a widget form. In response to an input indicating selection of the media contents 120, the electronic device 101 may initiate execution of a software application for displaying the media contents 120. The media contents 120 may include deep link information for executing each of the media contents 120 by using the software application. The deep link information may mean uniform resource locator (URL) information that connects to a software application, website, and/or web content for executing the media contents 120.

The electronic device 101 according to an embodiment may display the media contents 120 corresponding to each of the plurality of external objects 110 on a portion of the plane 115 by controlling a projection assembly (e.g., the projection assembly 230 of FIG. 2). For example, the electronic device 101 may include an actuator for movement. The electronic device 101 may move toward the portion for displaying the media contents 120 by using the actuator.

For example, the electronic device 101 may display the media content 321 corresponding to the external object 311 at a location corresponding to the external object 311, based on obtaining the media content 321. The media content 321 may mean images stored in the electronic device 101, at least one server, and/or an external electronic device (e.g., the external electronic device 102 of FIG. 2). The electronic device 101 may receive information indicating the media content 321 from the at least one server and/or the external electronic device. For example, the electronic device 101 may obtain the media content 322 corresponding to the external object 312. The media content 322 may include an electronic book. As another non-limiting example, the electronic device 101 may obtain the media content 323 indicating a record, based on identifying the external object 313.

The electronic device 101 according to an embodiment may display, based on obtaining the media contents 120, the media contents 120 using the projection assembly, based on a shape of the plurality of external objects 110. The electronic device 101 may adjust a location, a shape, and/or the number of each of the media contents 120 to be displayed, based on the shape.

The electronic device 101 according to an embodiment may identify a portion 305 of the plane 115 adjacent to the plurality of external objects 110 by using the camera. The electronic device 101 may set the number of the media contents 120 to be displayed on the portion 305, based on a size of the portion 305.

For example, the number of the media contents 120 may be set using a size of a real object (e.g., a bookshelf or a shelf) including the plurality of external objects 110. The electronic device 101 may adjust the number of displayable media contents 120 by comparing a ratio (e.g., a height-to-length ratio of a book) of each of the plurality of external objects 110 with a designated constant (e.g., a constant indicating a size of a book cover). However, it is not limited thereto. As an example, the electronic device 101 may adjust the number by receiving a user input.

The electronic device 101 according to an embodiment may identify a user 105 by using the camera or other means. The electronic device 101 may obtain user information (e.g., the user information 221 of FIG. 2) corresponding to the user 105, based on identifying the user 105. The electronic device 101 may obtain the media contents 120 corresponding to the plurality of external objects 110 and/or the user information, based on obtaining the user information. For example, the electronic device 101 may obtain the media contents 120 corresponding to the user 105, based on executing a software application (e.g., the multimedia application 223 of FIG. 2) to which the user 105 is logged in or able to log in.

For example, the electronic device 101 may obtain information (e.g., the external electronic device information 225 of FIG. 2) on external electronic devices owned or controlled by the user 105, based on identifying the user 105. The electronic device 101 may transmit a signal requesting initiation of execution of at least one media content to an external electronic device, based on obtaining the information. The selection of the external device to which the signal is transmitted may be based on the application for executing the media content or may be based on the media content. An operation in which the electronic device 101 transmits the signal is described below in FIG. 8.

For example, the electronic device 101 may obtain a usage history for each of the media contents 120 corresponding to the user 105, based on the execution of the software application. The electronic device 101 may obtain an order of the media contents 120, based on obtaining the usage history. The order may mean an order of priority of the media contents 120 to be displayed based on a size of a plane.

For example, the electronic device 101 may obtain the order based on a date of purchase of each of the media contents 120. The electronic device 101 may obtain the order based on a reading history or playing history for each of the media contents 120. However, it is not limited thereto. As an example, the electronic device 101 may obtain the order based on the date of purchase, reading history, bookmark, recommendation, etc., using a designated weight. The electronic device 101 may display the media contents 120 on the portion 305 by using the projection assembly, based on the order.

The electronic device 101 according to an embodiment may identify behavior of the user 105 over a designated period of time using the camera. For example, the electronic device 101 may identify the behavior of the user 105, such as frequently using the external object 312 among the plurality of external objects 110. The electronic device 101 may configure the media content 322 corresponding to the external object 312 with media contents that have a relatively high number of viewings, based on identifying the behavior of the user 105. However, it is not limited thereto. As an example, the electronic device 101 may display the media contents 120 based on the shape of the plurality of external objects 110 that has been changed by the behavior of the user 105.

As described above, the electronic device 101 according to an embodiment may identify the plurality of external objects 110 using the camera. The electronic device 101 may obtain the media contents 120 for the plurality of external objects 110 by using information on the user 105. The electronic device 101 may adjust a location in which the media contents 120 are to be displayed, based on identifying the shape of the plurality of external objects 110 and/or the behavior of the user 105. The electronic device 101 may provide a user interface (UI) that is harmonious with an external space in which the user 105 is located, by displaying the media contents 120 based on the shape of the plurality of external objects 110 and/or the behavior of the user 105.

FIG. 4 illustrates an exemplary flowchart indicating an operation of an electronic device according to an embodiment. An electronic device 101 of FIG. 4 may include the electronic device 101 of FIGS. 1 to 3. At least one of operations of FIG. 4 may be performed by the electronic device 101 of FIG. 2 and/or the processor 210 of FIG. 2. Each of the operations of FIG. 4 may be performed sequentially, but is not necessarily performed sequentially. For example, an order of each of the operations may be changed, and at least two operations may be performed in parallel.

Referring to FIG. 4, in operation 410, an electronic device according to an embodiment may identify a plurality of external objects in an image obtained using a camera. The electronic device may identify a type of each of the plurality of external objects, based on identifying an exterior of the plurality of external objects (e.g., the plurality of external objects 110 of FIG. 1).

Referring to FIG. 4, in operation 420, the electronic device according to an embodiment may obtain information of an application for executing, playing, displaying, implementing, rendering, or otherwise interacting with one or more media contents corresponding to the plurality of external objects. The application may be one or more, corresponding to each of the one or more media contents. The application may be, as an example, a software application to which a user identified by the electronic device using a camera is logged in or able to log in. The electronic device may identify one or more media contents based on a type of the plurality of external objects.

Referring to FIG. 4, in operation 430, the electronic device according to an embodiment may obtain a usage history for each of the one or more media contents by using information of an application accessible to a user, where the user may be identified using the camera. For example, the usage history may include a date of purchase and a viewing date for each of the one or more media contents, whether it was bookmarked, and/or information on an external electronic device that executed each of the one or more media contents.

Referring to FIG. 4, in operation 440, the electronic device according to an embodiment may obtain an order of one or more media contents to be displayed by controlling a projection assembly by using the usage history. The electronic device may obtain the order by requesting the order from an external server providing an application.

Referring to FIG. 4, in operation 450, the electronic device according to an embodiment may identify a plane on which one or more media contents adjacent to the plurality of external objects in the image are to be displayed. The electronic device may adjust the number of the one or more media contents based on a size of a plane identified using the camera.

Referring to FIG. 4, in operation 460, the electronic device according to an embodiment may display one or more media contents on a plane by controlling the projection assembly based on the order. The electronic device may set a shape of the one or more media contents based on a shape of the plurality of external objects or based on a size of the content being displayed. The electronic device may display the one or more media contents on a plane by controlling the projection assembly, based on the shape of the one or more media contents.

FIGS. 5A and 5B illustrate an example of an operation in which an electronic device according to an embodiment displays media contents based on identifying one user. An electronic device 101 of FIGS. 5A and 5B may be an example of the electronic device 101 of FIGS. 1 to 4.

Referring to FIG. 5A, the electronic device 101 according to an embodiment may identify a user 105 by using a camera. The electronic device may identify the user 105 by using suitable sensors in addition to the camera. For example, the electronic device 101 may identify the user 105 (or a position of the user 105, an external electronic device adjacent to the user 105, etc.) based on an ultra-wide band (UWB) by using communication circuitry. For example, the electronic device 101 may identify the user 105 adjacent to the electronic device 101 based on identifying an external electronic device (e.g., the external electronic device 102 of FIG. 1) to which the user 105 is logged in by using the communication circuitry.

The electronic device 101 according to an embodiment may identify a location of the user 105 in an external space in which the electronic device 101 is located, by using the camera. For example, the electronic device 101 may identify the user 105 located in a direction (e.g., an x direction of FIG. 5A), in a state in which the projection assembly is oriented towards a plane 115. However, it is not limited thereto. For example, the electronic device 101 may receive information indicating the location of the user 105 from at least one external electronic device through the communication circuitry.

For example, the electronic device 101 may infer a viewpoint 501 of the user 105 based on identifying the location of the user 105. The viewpoint 501 may be obtained based on identifying a gaze direction of the user 105 looking at media contents 120 from the location. The electronic device 101 may identify the gaze direction using an image obtained by using the camera. For example, the electronic device 101 may identify the gaze direction based on identifying the location of the user 105. The electronic device 101 may obtain a form in which the media contents 120 will be visible to the user 105, based on inferring the viewpoint of the user 105. The form in which the media contents 120 will be visible may be set based on three dimensions. However, it is not limited thereto.

For example, the electronic device 101 may identify a plurality of users through the camera and/or the communication circuitry. When each of the plurality of users is located in a designated range, the electronic device 101 may obtain a form of the media contents 120 based on a representative viewpoint (e.g., the viewpoint 501). The electronic device 101 may obtain the representative viewpoint based on a center point of the designated range. As an example, the electronic device 101 may identify the representative viewpoint based on a viewpoint corresponding to at least one user among the plurality of users.

FIG. 5B illustrates an example of an operation in which the electronic device 101 according to an embodiment adjusts a location in which the media contents 120 are to be displayed on a plane (e.g., the plane 115 of FIG. 5A) adjacent to a plurality of external objects 110, based on a viewpoint of the user 105 (e.g., the viewpoint 501 of FIG. 5A).

Referring to FIG. 5B, the electronic device 101 according to an embodiment may identify a distance 512 between the user 105 and the plurality of external objects 110, based on identifying the location of the user 105. The electronic device 101 may identify the distance 512 using a sensor (e.g., a ToF sensor). For example, the distance 512 may change according to the location of the user 105.

The electronic device 101 may obtain a length 511 of a real object (e.g., a bookshelf or a shelf) including the plurality of external objects 110 in the image obtained through the camera. For example, the electronic device 101 may receive information on a size of the real object from an external electronic device. The electronic device 101 may obtain the length 511 based on receiving the information. For example, the electronic device 101 may identify a point 515 that matches a line extended from the user 105 in a direction (e.g., a y-direction of FIG. 5B) in which the plurality of external objects 110 are located. The direction may match the gaze direction in which the user 105 is looking at the plurality of external objects 110. The electronic device 101 may obtain a width 510 from the point 515 to an edge of the real object, based on identifying the point 515. The edge may mean an edge of the real object corresponding to the length 511. The width 510 obtained by the electronic device 101 may change according to the location of the user 105.

The electronic device 101 according to an embodiment may obtain a spacing distance 513 based on obtaining the length 511, the distance 512, and/or the width 510. The spacing distance 513 may be used to prevent the media contents 120, which are to be displayed on the plane, from being obscured by the plurality of external objects 110 from the viewpoint of the user 105 (e.g., the viewpoint 501 of FIG. 5A). The electronic device 101 may obtain the spacing distance 513 using Equation 1, which will be described below.

$$Equation 1$$

$$d = w * a / b \qquad Eqn ( 1 )$$

Referring to Equation 1, d may mean the spacing distance 513, w may mean the width 510, a may mean the length 511, and b may mean the distance 512. For example, by obtaining the spacing distance 513 using Equation 1, the electronic device 101 may display the media contents e120 on a portion (e.g., the portion 305 of FIG. 3) spaced apart by the spacing distance 513 from the plurality of external objects 110, by controlling the projection assembly. A form of the displayed media contents 120 may include a three-dimensional-based form, by using the location of the user 105. However, it is not limited thereto. The electronic device 101 may obtain the spacing distance 513 independently of identifying the location of the user 105. As an example, the electronic device 101 may display the media contents 120 independently of using the spacing distance 513.

In an embodiment, when a plurality of users are located in a designated range from the electronic device 101, the electronic device 101 may display the media contents 120 based on a three-dimensional form using the Equation 1, based on a representative viewpoint corresponding to the plurality of users. As an example, when a direction in which the plurality of users are looking at the media contents 120 is substantially the same, the electronic device 101 may identify a representative viewpoint based on the direction. The electronic device 101 may display the media contents 120 by using the Equation 1, based on the identified representative viewpoint.

As described above, the electronic device 101 according to an embodiment may change the form of the media contents 120 based on identifying the location of the user 105. The electronic device 101 may provide a more realistic augmented reality service compared to displaying the media contents 120 based on two dimensions, by changing the form of the media contents 120.

FIGS. 6A and 6B illustrate an example of an operation in which an electronic device according to an embodiment displays media contents based on identifying a plurality of users. An electronic device 101 of FIGS. 6A and 6B may be an example of the electronic device 101 of FIGS. 1 to 5B.

Referring to FIG. 6A, the electronic device 101 according to an embodiment may identify, using a camera, a plurality of users 105 and 601 located in a designated distance from the electronic device 101. The electronic device 101 may display media contents 120 corresponding to each of the plurality of users 105 and 601 on a plane 115 by controlling a projection assembly, based on identifying the plurality of users 105 and 601. The electronic device 101 may obtain the media contents 120 based on execution of a software application accessible to each of the plurality of users 105 and 601. The designated distance may be set according to a size of an external space in which the electronic device 101 is located.

The electronic device 101 according to an embodiment may infer a state in which the plurality of users 105 and 601 are simultaneously viewing the media contents 120, based on identifying the plurality of users 105 and 601 included in the designated distance. The electronic device 101 may obtain a form of the media contents 120 based on identifying the plurality of users 105 and 601. The form of the media contents 120 may include a two-dimensional-based form. For example, the electronic device 101 may obtain the two-dimensional-based form based on execution of a software application for executing some or all of the media contents 120. However, it is not limited to the above-described embodiment. As an example, when the electronic device 101 identifies one user (e.g., the user 105), it may display the media contents 120 including a two-dimensional-based form, based on predicting movement of the user.

Referring to FIG. 6B, the electronic device 101 according to an embodiment may identify a location of each of the plurality of users 105 and 601. The electronic device 101 may determine the form of the media contents 120 using an angle between the plurality of users 105 and 601. For example, the electronic device 101 may identify an angle 605 between the user 105 and the user 601 based on a point (e.g., a center point) of the media contents 120. Based on determining that the angle 605 is less than a designated threshold, the electronic device 101 may obtain the media contents 120 in a three-dimensional form based on a representative viewpoint (e.g., the viewpoint 501 of FIG. 5A). Based on determining that the angle 605 is greater than or equal to the designated threshold, the electronic device 101 may obtain the media contents 120 in a two-dimensional form. For example, when the electronic device 101 identifies a plurality of users greater than or equal to three, it may identify an angle between at least two of the plurality of users that is greater than or equal to the designated threshold. The electronic device 101 may display the media contents 120 based on the two-dimensional form on a plane (e.g., the plane 115 of FIG. 1) by controlling the projection assembly, based on identifying the angle. However, it is not limited thereto. For example, the electronic device may set the form of the media contents 120 based on the location of each of the plurality of users 105 and 601.

The electronic device 101 according to an embodiment may display at least one of the media contents 120 based on a three-dimensional form, using a viewpoint of the user 105 among the plurality of users 105 and 601. For example, the at least one of the media contents 120 may be executed based on an application accessible to the user 105.

As described above, the electronic device 101 according to an embodiment may set the form of the media contents 120 based on identifying the plurality of users 105 and 601. The form may be changed based on the locations of the plurality of users 105 and 601. The electronic device 101 may set the form of the media contents 120 using the angle 605 between the plurality of users 105 and 601. The electronic device 101 may set the form of the media contents 120 in various ways based on viewpoints of the plurality of users 105 and 601.

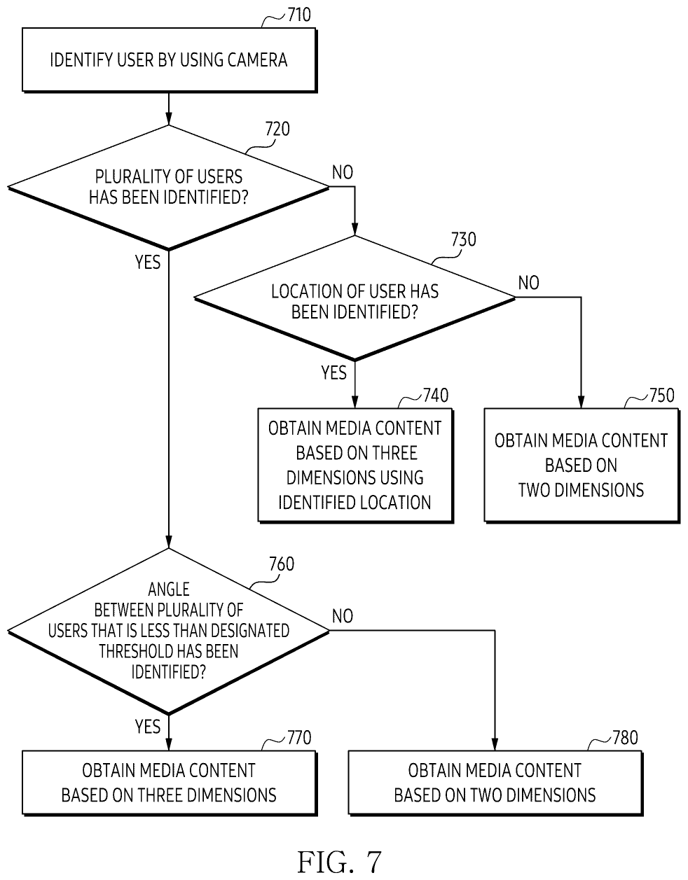

FIG. 7 illustrates an exemplary flowchart indicating an operation of an electronic device according to an embodiment. An electronic device 101 of FIG. 7 may include the electronic device 101 of FIGS. 1 to 6B. At least one of operations of FIG. 7 may be performed by the electronic device 101 of FIG. 2 and/or the processor 210 of FIG. 2. Each of the operations of FIG. 7 may be performed sequentially, but is not necessarily performed sequentially. For example, an order of each of the operations may be changed, and at least two operations may be performed in parallel.

Referring to FIG. 7, in operation 710, the electronic device according to an embodiment may identify a user by using a camera. For example, the electronic device may identify the user using the user information 221 of FIG. 2. The electronic device may obtain information on a software application accessible to the user based on identifying the user. The electronic device may obtain media content corresponding to a plurality of external objects obtained using the camera, based on execution of the software application.

Referring to FIG. 7, in operation 720, the electronic device according to an embodiment may determine whether a plurality of users has been identified. software applications accessible to the plurality of users may be different for each. The electronic device may identify external electronic device information (e.g., the external electronic device information 225 of FIG. 2) corresponding to each of the plurality of users. The operation in which the electronic device initiates execution of media content using the external electronic device information is described below in FIG. 8.

Referring to FIG. 7, in a case that a plurality of users are not identified (the operation 720-NO), in operation 730, the electronic device according to an embodiment may confirm whether a location of the user has been identified. The electronic device may identify, using a camera, the location of the user in an external space in which the electronic device is located. The electronic device may obtain a viewpoint of the user (e.g., the viewpoint 501 of FIG. 5A) based on identifying the location of the user.

Referring to FIG. 7, in a case that the location of the user has been identified (the operation 730-YES), in operation 740, the electronic device according to an embodiment may obtain media content based on three dimensions using the identified location. Media content that the electronic device displays by controlling a projection assembly may be referred to as the media contents 120 of FIG. 5A. The electronic device may obtain a spacing distance (e.g., the spacing distance 513 of FIG. 5B) using Equation 1 of FIG. 5B, based on identifying the location of the user. The electronic device may display the media content (e.g., the media contents 120 of FIG. 5B) on a plane adjacent to a plurality of external objects (e.g., the plurality of external objects 110 of FIG. 5B) by controlling the projection assembly using the spacing distance.

Referring to FIG. 7, in a case that the location of the user is not identified (the operation 730-NO), in operation 750, the electronic device according to an embodiment may obtain media content based on two dimensions. For example, the case in which the location of the user is not identified may include a case in which the electronic device identifies the user disposed at a location greater than or equal to a designated distance from the electronic device. For example, the case in which the location of the user is not identified may include a case in which an angle between the plane on which the media content is to be displayed and the user is greater than or equal to a designated angle.

Referring to FIG. 7, in a case that a plurality of users are identified (the operation 720-YES), in operation 760, the electronic device according to an embodiment may confirm whether it has identified an angle between the plurality of users that is less than a designated threshold. For example, the electronic device may identify, using the camera, an angle between the plurality of users and the plane on which the media content is to be displayed. For example, the electronic device may identify the angle based on a location of each of the plurality of users.

Referring to FIG. 7, in a case that an angle between the plurality of users that is less than the designated threshold is identified (the operation 760-YES), in operation 770, the electronic device according to an embodiment may obtain media content based on three dimensions. The electronic device may obtain a representative viewpoint corresponding to the plurality of users, based on identifying the angle between the plurality of users that is less than the designated threshold. The representative viewpoint may include a viewpoint of at least one user among the plurality of users. The electronic device may identify a form of media content corresponding to the representative viewpoint. The electronic device may display the media content by controlling the projection assembly based on the form.

Referring to FIG. 7, in a case that an angle between the plurality of users that is greater than or equal to the designated threshold is not identified (the operation 760-NO), in operation 780, the electronic device according to an embodiment may obtain media content based on two dimensions. The media content based on two dimensions displayed by the electronic device may be referred to as the media contents 120 of FIG. 6A.

FIG. 8 illustrates an example of an operation in which an electronic device according to an embodiment requests initiation of execution of media content to an external electronic device of a user identified using a camera. An electronic device 101 of FIG. 8 may be an example of the electronic device 101 of FIGS. 1 to 7.

Referring to FIG. 8, the electronic device 101 according to an embodiment may display media contents 120 corresponding to a plurality of external objects 110 on a plane 115. Based on identifying the user (e.g., the user 105 of FIG. 1) using the camera, the electronic device 101 may display the media contents 120 corresponding to the user. The media contents 120 may be obtained based on execution of a software application (e.g., the multimedia application 223 of FIG. 2) to which the user is logged in or is able to log in. The media contents 120 may be obtained based on execution of one or more software applications. For example, a software application corresponding to media content 322 and a software application corresponding to media content 323 may be different. However, it is not limited thereto.

In an embodiment where the electronic device 101 identifies a plurality of users, it may obtain media content corresponding to each of the plurality of users. For example, the electronic device 101 may obtain media content (e.g., media content 322) corresponding to a first user (e.g., the user 105 of FIG. 6B) among the plurality of users, and obtain media content (e.g., media content 323) corresponding to a second user (e.g., the user 601 of FIG. 6B) different from the first user. In embodiments, the electronic device 101 may obtain media content (e.g., the media content 322) based on execution of a first software application to which the first user is logged in or is able to log in. The electronic device 101 may also obtain media content (e.g., the media content 323) based on execution of a second software application to which the second user is logged in or is able to log in. However, it is not limited thereto. For example, the electronic device 101 may obtain information on the media contents from external electronic devices owned by each of the plurality of users.

The electronic device 101 according to an embodiment may display a visual object 810 for executing at least one of the media contents 120, in response to an input indicating selection of the at least one. For example, the visual object 810 may include information on an external electronic device 102.

For example, the electronic device 101 may identify information on an external electronic device owned by the user (e.g., the external electronic device information 225 of FIG. 2), based on identifying the user using the camera. The electronic device 101 may identify the external electronic device 102 based on identifying the information.

For example, the electronic device 101 may identify the external electronic device 102 based on obtaining a usage history for each of the media contents 120. The electronic device 101 may identify the external electronic device 102 based on obtaining a usage history of executing at least one of the media contents 120 using the external electronic device 102. As an example, the electronic device 101 may identify the external electronic device 102 in response to an input indicating selection of the external electronic device 102 among a plurality of external electronic devices to which the user is logged in.

The electronic device 101 according to an embodiment may receive an input for a visual object 811 based on displaying the visual object 810. The electronic device 101 may receive the input based on identifying contact or interaction between the visual object 811 and a body part of the user. The electronic device 101 may identify the input using the camera or other sensors in combination with the camera. The electronic device 101 may receive the input based on at least one controller. However, it is not limited thereto.

For example, the electronic device 101 may initiate execution of at least one of the media contents 120 based on receiving the input for the visual object 811. The electronic device 101 may initiate execution of a software application (e.g., the multimedia application 223 of FIG. 2) corresponding to at least one of the media contents 120. The electronic device 101 may execute at least one of the media contents 120 based on the execution of the software application. Based on executing at least one of the media contents 120, the electronic device 101 may display a screen based on the at least one by controlling the projection assembly.

The electronic device 101 according to an embodiment may identify an input indicating selection of a visual object 812. The electronic device 101 may transmit a signal requesting execution of at least one of the media contents 120 to the external electronic device 102, using communication circuitry, based on identifying the input. For example, a type of the external electronic device 102 to which the electronic device 101 transmits the signal may be determined according to a type of at least one of the media contents 120 or the software application. For example, in a case that at least one of the media contents 120 is a type related to a record, the type of the external electronic device 102 may include an electronic device including a speaker or a device able to play the content of the record. However, it is not limited thereto. As an example, in a case that at least one of the media contents 120 includes text information, the electronic device 101 may identify the external electronic device 102 including a display for displaying text indicated by the text information.

For example, the signal may include a deep link corresponding to at least one of the media contents 120. The deep link may include information on a software application corresponding to at least one of the media contents 120.

For example, the external electronic device 102 may initiate execution of a software application (e.g., the multimedia application 223 of FIG. 2) corresponding to at least one of the media contents 120, based on receiving the signal. The external electronic device 102 may display a visual object 821 for initiating the execution of the software application on a display 260. The external electronic device 102 may receive an input for a visual object 822 based on displaying the visual object 821. The external electronic device 102 may display a screen based on at least one of the media contents 120, based on receiving the input. The screen displayed by the external electronic device 102 may be referred to as the screen 125 of FIG. 1.

The electronic device 101 according to an embodiment may receive an input indicating selection of at least one of the media contents 120. At least one of the media contents 120 may include media content corresponding to another user different from the user identified by the electronic device 101. Based on receiving an input for the media content corresponding to the other user, the electronic device 101 may display a visual object for downloading or purchasing the media content by controlling the projection assembly.

For example, the electronic device 101 may transmit a signal for downloading or purchasing the media content to the external electronic device 102 through the communication circuitry. The external electronic device 102 may display the visual object for downloading or purchasing the media content on the display 260 based on receiving the signal.

As described above, the electronic device 101 according to an embodiment may use an external electronic device to execute the media contents 120. The electronic device 101 may provide a more convenient Internet of Things (IOT) environment to the user by using an external electronic device corresponding to each of the media contents 120.

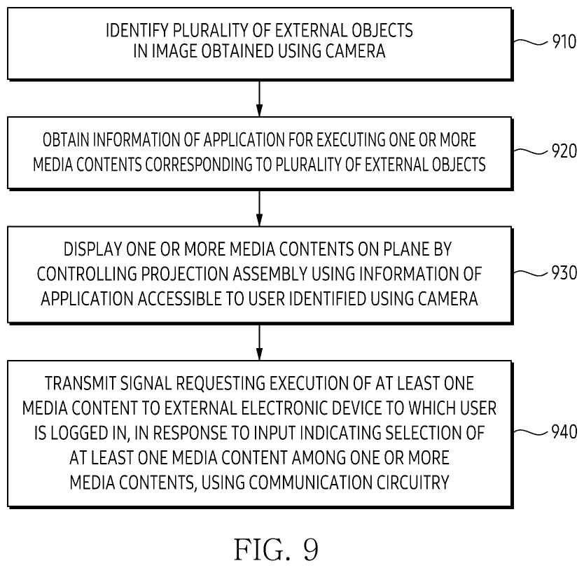

FIG. 9 illustrates an exemplary flowchart indicating an operation of an electronic device according to an embodiment. An electronic device 101 of FIG. 9 may include the electronic device 101 of FIGS. 1 to 8. At least one of operations of FIG. 9 may be performed by the electronic device 101 of FIG. 2 and/or the processor 210 of FIG. 2. Each of the operations of FIG. 9 may be performed sequentially, but is not necessarily performed sequentially. For example, an order of each of the operations may be changed, and at least two operations may be performed in parallel.

Referring to FIG. 9, in operation 910, the electronic device according to an embodiment may identify a plurality of external objects in an image obtained using a camera. The electronic device may identify media content corresponding to each of the plurality of external objects, based on a type of each of the plurality of external objects (e.g., the plurality of external objects 110 of FIG. 1).

Referring to FIG. 9, in operation 920, the electronic device according to an embodiment may obtain information of an application for executing one or more media contents corresponding to the plurality of external objects. A type of the application may vary according to the type of the plurality of external objects. For example, the electronic device may request information on the one or more media contents (e.g., the media contents 120 of FIG. 1) from a server that provides the application by using communication circuitry. The electronic device may identify the one or more media contents based on receiving the information from the server.

Referring to FIG. 9, in operation 930, the electronic device according to an embodiment may display one or more media contents on a plane by controlling a projection assembly using information of an application accessible to a user identified using the camera. The electronic device may identify a location for displaying the one or more media contents based on a location of the plurality of external objects (e.g., the plurality of external objects 110 of FIG. 1). The electronic device may set a form of the one or more media contents based on the number of the identified users. The form may be changed based on the number of the users and/or the location of the user.

Referring to FIG. 9, in operation 940, the electronic device according to an embodiment may transmit a signal requesting execution of at least one media content to an external electronic device to which the user is logged in, in response to an input indicating selection of at least one media content among the one or more media contents, using the communication circuitry. The electronic device may identify external electronic device information (e.g., the external electronic device information 225 of FIG. 2) corresponding to the user. The electronic device may identify an external electronic device capable of executing the at least one media content based on the external electronic device information. The electronic device may identify the external electronic device based on a type of the at least one media content. The external electronic device may initiate execution of an application corresponding to the at least one media content for executing the at least one media content, based on receiving the signal. A screen based on the at least one media content displayed by the external electronic device based on the execution of the application may be referred to as the screen 125 of FIG. 1.

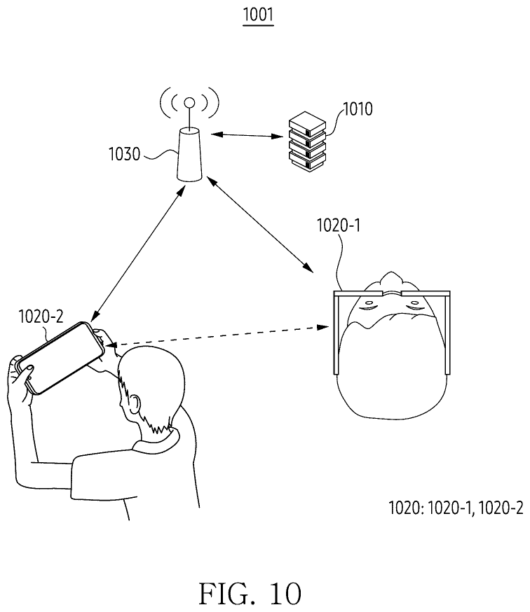

FIG. 10 is an exemplary diagram of a network environment related to a metaverse service.

Metaverse is a compound word of the English words “Meta” meaning “virtual” and “transcendence” and “Universe” meaning cosmos, and refers to a three-dimensional virtual world in which social, economic, and cultural activities take place like a real world. Metaverse is a concept that has evolved one step further than a virtual reality (VR, cutting-edge technology that enables people to experience real-life experiences in a virtual world created by a computer), and it is characterized by using avatars to not only enjoy games or virtual reality, but also social and cultural activities like a reality. A metaverse service may provide media content for enhancing immersion in the virtual world, based on an augmented reality (AR), a virtual reality environment (VR), a mixed environment (MR), and/or an extended reality (XR).

For example, media content provided by the metaverse service may include social interaction content including avatar-based game, concert, party, and/or meeting. For example, the media content may include information for economic activities such as advertising, user created content, and/or sales and/or shopping of productions. Ownership of the user created content may be proved by a blockchain-based non-fungible token (NFT). The metaverse service may support economic activities based on real money and/or cryptocurrency. By the metaverse service, virtual content associated with the real world, such as digital twin or life logging, may be provided.

FIG. 10 is an exemplary diagram of a network environment 1001 in which a metaverse service is provided through a server 1010.

Referring to FIG. 10, a network environment 1001 may include a server 1010, a user terminal 1020 (e.g., a first terminal 1020-1 and a second terminal 1020-2), and a network connecting the server 1010 and the user terminal 1020. In the network environment 1001, the server 1010 may provide a metaverse service to the user terminal 1020. The network may be formed by at least one intermediate node 1030 including an access point (AP) and/or a base station. The user terminal 1020 may access the server 1010 through the network and output a user interface (UI) associated with a metaverse service to a user of the user terminal 1020. Based on the UI, the user terminal 1020 may obtain information to be inputted into the metaverse service from the user, or output information (e.g., multimedia content) associated with the metaverse service to the user.

In this case, the server 1010 provides a virtual space so that the user terminal 1020 may perform activities in the virtual space. In addition, the user terminal 1020 may represent information provided by the server 1010 to the user by installing an S/W agent to access the virtual space provided by the server 1010, or transmit information that the user wants to represent in the virtual space to the server. The S/W agent may be provided directly through the server 1010, downloaded from a public server, or embedded and provided when purchasing a terminal.

In an embodiment, the metaverse service may provide a service to the user terminal 1020 and/or a user by using the server 1010. The embodiment is not limited thereto, and the metaverse service may be provided through individual contacts between users. For example, in the network environment 1001, the metaverse service may be provided by a direct connection between the first terminal 1020-1 and the second terminal 1020-2, independently of the server 1010. Referring to FIG. 10, in the network environment 1001, the first terminal 1020-1 and the second terminal 1020-2 may be connected to each other through a network formed by at least one intermediate node 1030. In an embodiment in which the first terminal 1020-1 and the second terminal 1020-2 are directly connected, any one of the first terminal 1020-1 and the second terminal 1020-2 may perform a role of the server 1010. For example, a metaverse environment may be configured only with a device-to-device connection (e.g., a peer-to-peer (P2P) connection).

In an embodiment, the user terminal 1020 (or the user terminal 1020 including the first terminal 1020-1 and the second terminal 1020-2) may be made in various form factors, and it is characterized by including an output device for providing an image and/or sound to the user and an input device for inputting information into the metaverse service. An exemplary user terminal 1020 in various form factors may include a smartphone (e.g., the second terminal 1020-2), an AR device (e.g., the first terminal 1020-1), a VR device, an MR device, a Video See Through (VST) device, an Optical See Through (OST) device, a smart lens, a smart mirror, a TV capable of inputting and outputting, or a projector.

A network (e.g., a network formed by at least one intermediate node 1030) includes all of various broadband networks including 3G, 4G, and 5G and short-range networks (e.g., a wired network or a wireless network that directly connects the first terminal 1020-1 and the second terminal 1020-2) including Wi-Fi and BT.

An electronic device according to an embodiment may obtain media contents corresponding to a plurality of external objects using a camera. To obtain the media contents corresponding to the plurality of external objects, the electronic device may identify at least one application. A method may be required for the electronic device to obtain the media contents corresponding to the plurality of external objects using the camera.

As described above, in an electronic device 101 according to an embodiment, the electronic device may comprise a camera 240, communication circuitry 250, a projection assembly 230, and a processor 210. The processor may identify a plurality of external objects 110 in an image obtained using the camera. The processor may obtain information of an application 223 for executing one or more media contents 120 corresponding to the plurality of external objects. The processor may display the one or more media contents on a plane 115 by controlling the projection assembly using the information of the application accessible to a user 105 identified using the camera. The processor may be configured to, in response to an input 121 indicating selection of at least one media content among the one or more media contents, transmit, to an external electronic device 102 to which the user is logged in, using the communication circuitry, a signal requesting execution of the at least one media content.

For example, the processor may obtain a usage history for each of the one or more media contents by using the information of the application. The processor may be configured to obtain an order of the one or more media contents to be displayed by controlling the projection assembly by using the usage history.

For example, the processor may be configured to, in response to the input, identify the external electronic device by using the usage history.

For example, the processor may identify the plane on which the one or more media contents adjacent to the plurality of external objects in the image are to be displayed. The processor may be configured to display, by controlling the projection assembly, based on the order, the one or more media contents on the plane.

For example, the processor may be configured to identify, based on a size of the plane, the number of the one or more media contents to be displayed on the plane.

For example, the processor may be configured to set, using the camera, based on identifying a location of the user, a form of the one or more media contents to be displayed on the plane.

For example, the processor may be configured to set, in a state where a plurality of users 105 and 601 including the user is identified, a form of the one or more media contents, based on identifying an angle 605 between a first user 105 as the user and a second user 601 distinct from the first user among the plurality of users.

For example, the processor may be configured to display the one or more media contents based on a shape in which the plurality of external objects are arranged in the image.

As described above, in a method of an electronic device 101 according to an embodiment, the method may comprise identifying a plurality of external objects 110 in an image obtained using a camera 240. The method may comprise obtaining information of an application 223 for executing one or more media contents 120 corresponding to the plurality of external objects. The method may comprise displaying the one or more media contents on a plane 115 by controlling a projection assembly 230 using the information of the application accessible to a user 105 identified using the camera. The method may comprise, in response to an input 121 indicating selection of at least one media content among the one or more media contents, transmitting, to an external electronic device 102 to which the user is logged in, using communication circuitry 250, a signal requesting execution of the at least one media content.

For example, obtaining the information of the application may comprise obtaining a usage history for each of the one or more media contents by using the information of the application. Obtaining the information of the application may comprise obtaining an order of the one or more media contents to be displayed by controlling the projection assembly by using the usage history.

For example, transmitting the signal may comprise, in response to the input, identifying the external electronic device by using the usage history.

For example, displaying the one or more media contents on the plane may comprise identifying the plane on which the one or more media contents adjacent to the plurality of external objects in the image are to be displayed. Displaying the one or more media contents on the plane may comprise displaying, by controlling the projection assembly, based on the order, the one or more media contents on the plane.

For example, displaying the one or more media contents on the plane may comprise identifying, based on a size of the plane, the number of the one or more media contents to be displayed on the plane.

For example, displaying the one or more media contents on the plane may comprise setting, using the camera, based on identifying a location of the user, a form of the one or more media contents to be displayed on the plane.

For example, displaying the one or more media contents on the plane may comprise setting, in a state where a plurality of users 105 and 601 including the user is identified, a form of the one or more media contents, based on identifying an angle 605 between a first user 105 as the user and a second user 601 distinct from the first user among the plurality of users.

As described above, in an electronic device 101 according to an embodiment, the electronic device may comprise a camera 240, communication circuitry 250, a projection assembly 230, and a processor 210. The processor may identify a plurality of external objects 110 in an image obtained using the camera. The processor may obtain information of an application 223 for executing one or more media contents 120 corresponding to the plurality of external objects. The processor may obtain a usage history for each of the one or more media contents by using the information of the application accessible to a user 105 identified using the camera. The processor may obtain an order of the one or more media contents to be displayed by controlling the projection assembly by using the usage history. The processor may identify a plane 115 on which the one or more media contents adjacent to the plurality of external objects in the image are to be displayed. The processor may be configured to display the one or more media contents on the plane by controlling the projection assembly based on the order.

For example, the processor may be configured to, in response to an input 121 indicating selection of at least one media content among the one or more media contents, transmit, to an external electronic device 102 using the communication circuitry, a signal requesting execution of the at least one media content.

For example, the processor may be configured to identify the external electronic device capable of executing the at least one media content, based on a type of the at least one media content.

For example, the processor may be configured to, based on identifying the user, transmit, to the external electronic device, a second signal different from a first signal which is the signal requesting the information of the application.

For example, the processor may be configured to transmit the signal in response to another input, different from the input, for transmitting the signal to the external electronic device.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. An electronic device, comprising:
a camera;
communication circuitry;
a projection assembly;
at least one processor comprising processing circuitry; and
memory comprising one or more storage mediums storing instructions,
wherein the instructions, when executed by the at least one processor of the electronic device, individually or collectively, cause the electronic device to:
identify a plurality of external objects in an image obtained using the camera,
obtain information about an application for performing one or more operations associated with one or more media contents, the one or more media contents being associated with the plurality of external objects,
control the projection assembly using the information about the application to display the one or more media contents on a plane, wherein the application is accessible to a user, and wherein the user is identified using the camera, and
in response to an input indicating selection of at least one media content among the one or more media contents, transmit, to an external electronic device associated with the user, a signal requesting execution of the one or more operations associated with of the at least one media content.

2. The electronic device of claim 1, wherein the instructions, when executed by the at least one processor individually or collectively, further cause the electronic device to:
obtain a usage history for each of the one or more media contents based on the information about the application, and
obtain an order for the one or more media contents to be displayed by controlling the projection assembly based on the usage history.

3. The electronic device of claim 2, wherein the instructions, when executed by the at least one processor individually or collectively, further cause the electronic device to:
in response to the input, identify the external electronic device based on the usage history.

4. The electronic device of claim 2, wherein the instructions, when executed by the at least one processor individually or collectively, further cause the electronic device to:
identify the plane near the plurality of external objects to display the one or more media contents, and
by controlling the projection assembly, based on the order, display the one or more media contents on the plane.

5. The electronic device of claim 1, wherein the instructions, when executed by the at least one processor individually or collectively, further cause the electronic device to:
based on a size of the plane or a shape of the plane, identify a number of the one or more media contents for display on the plane.

6. The electronic device of claim 1, wherein the instructions, when executed by the at least one processor individually or collectively, further cause the electronic device to:
using the camera, based on identifying a location of the user, set a form of the one or more media contents to be displayed on the plane.

7. The electronic device of claim 1, wherein the user is a first user, and wherein the instructions, when executed by the at least one processor individually or collectively, further cause the electronic device to:
based on a plurality of users being identified, set a form of the one or more media contents, based on an angle between the first user and a second user distinct from the first user among the plurality of users.

8. The electronic device of claim 1, wherein the instructions, when executed by the at least one processor individually or collectively, further cause the electronic device to:
display the one or more media contents based on a shape in which the plurality of external objects are arranged in the image.

9. The electronic device of claim 1, wherein the user is a first user, and wherein the instructions, when executed by the at least one processor individually or collectively, further cause the electronic device to:
obtain an angle between the first user and a second user among a plurality of users;
obtain a representative viewpoint with respect to both the first user and the second user; and
control the projection assembly to display the one or more media contents on the plane in a three-dimensional form based on the representative viewpoint.

10. A method of operation of an electronic device, the method being executed by at least one processor of the electronic device, individually or collectively, the method comprising:
identifying a plurality of external objects in an image obtained using a camera,
obtaining information about an application for performing one or more operations associated with one or more media contents, the one or more media contents being associated with the plurality of external objects,
controlling the projection assembly using the information about the application to displaying the one or more media contents on a plane, wherein the application is accessible to a user, and wherein the user is identified using a camera, and
in response to an input indicating selection of at least one media content among the one or more media contents, transmitting, to an external electronic device associated with the user, a signal requesting execution of the one or more operations associated with of the at least one media content.

11. The method of claim 10, wherein obtaining the information about the application comprises:
obtaining a usage history for each of the one or more media contents based on the information about the application, and
obtaining an order for the one or more media contents to be displayed by controlling the projection assembly based on the usage history.

12. The method of claim 11, wherein displaying the one or more media contents on the plane comprises:
identifying the plane near the plurality of external objects to display the one or more media contents, and
by controlling the projection assembly, based on the order, displaying the one or more media contents on the plane.

13. The method of claim 10, wherein displaying the one or more media contents on the plane comprises:
based on a size of the plane or a shape of the plane, identifying a number of the one or more media contents to be displayed on the plane.

14. The method of claim 10, wherein displaying the one or more media contents on the plane comprises:
using the camera, based on identifying a location of the user, setting a form of the one or more media contents to be displayed on the plane.

15. The method of claim 10, wherein the user is a first user, and wherein displaying the one or more media contents on the plane comprises:
based on a plurality of users being identified, setting a form of the one or more media contents, based on an angle between the first user and a second user distinct from the first user among the plurality of users.

16. An electronic device, comprising:
a camera;
communication circuitry;
a projection assembly;
at least one processor comprising processing circuitry; and
memory comprising one or more storage mediums storing instructions,
wherein the instructions, when executed by the at least one processor individually or collectively, cause the electronic device to:
identify a plurality of external objects in an image obtained using the camera,
obtain information about an application for performing one or more operations associated with one or more media contents, the one or more media contents being associated with the plurality of external objects,
obtain a usage history for each of the one or more media contents based on the information about the application accessible to a user, the user being identified using the camera;
obtain an order to display the one or more media contents by controlling the projection assembly and based on the usage history;
identify a plane near the plurality of external objects to display the one or more media contents; and
display the one or more media contents on the plane by controlling the projection assembly based on the order.

17. The electronic device of claim 16, wherein the instructions, when executed by the at least one processor individually or collectively, further cause the electronic device to:
in response to an input indicating selection of at least one media content among the one or more media contents, transmit, to an external electronic device associated with the user, a signal requesting execution of the one or more operations associated with of the at least one media content.

18. The electronic device of claim 17, wherein the instructions, when executed by the at least one processor individually or collectively, further cause the electronic device to:
identify the external electronic device capable of executing one or more operations associated with the at least one media content, based on a type of the at least one media content.

19. The electronic device of claim 17, wherein the instructions, when executed by the at least one processor individually or collectively, further cause the electronic device to:
based on identifying the user, transmit, to the external electronic device, a second signal different from a first signal which is the signal requesting the information about the application.

20. The electronic device of claim 17, wherein the input is a first input, and wherein the instructions, when executed by the at least one processor individually or collectively, further cause the electronic device to:
in response to a second input, different from the first input, transmit the signal to the external electronic device.
